(19) United States
(12) Patent Application Publication
(10) Pub. No.: US 2017/0089836 A1
(43) Pub. Date: Mar. 30, 2017

(54) Analysis Device

(71) Applicant: Hitachi High-Technologies Corporation, Minato-ku, Tokyo (JP)

(72) Inventors: Hirokazu KATO, Tokyo (JP); Tomohiro SHOJI, Tokyo (JP); Hiroyuki HIGASHINO, Tokyo (JP); Tatsuya YAMASHITA, Tokyo (JP); Mitsuru HARIGAE, Tokyo (JP)

(21) Appl. No.: 15/126,781

(22) PCT Filed: Mar. 11, 2015
(86) PCT No.: PCT/JP2015/057080

§ 371 Date: Sep. 16, 2016

(30) Foreign Application Priority Data
Apr. 3, 2014 (JP) 2014-077095

(51) Int. Cl. G01N 21/64; G01N 21/03; G01N 21/05

(52) U.S. Cl. CPC G01N 21/6458; G01N 21/05; G01N 21/0332; G01N 2021/6482

(57) ABSTRACT

An analysis device is provided with a flow chip provided at least with a light transmissive first substrate and a second substrate having an inlet and outlet for a fluid, a holding member for holding the flow chip, a fixing member on which the holding member is placed and that comes into contact with the second substrate of the flow chip, a fluid feeding unit for feeding the fluid to the inlet and discharging the fluid from the outlet, an optical detection unit disposed on the first substrate side of the flow chip, and a drive unit for driving the holding member in the X and Y directions.

### TECHNICAL FIELD

The present invention relates to an analysis device.

### BACKGROUND ART

In the human genome project spending a budget of 3 billion dollars between 1990 and 2005, techniques and methods required for decoding the genomes have been left as a legacy. These techniques have been further improved ever since, and in the present day, the genomes can be decoded at a cost of substantially 1,000 dollars with a level of accuracy that can withstand for practical use.

The core of next-generation sequence measurement is a flow chip to which many micro reaction fields are fixed. A chemical reaction is performed on the micro reaction field fixed onto the flow chip, and a fluorescent signal emitted therefrom is analyzed, so that the base sequence of the nucleic acid can be analyzed. A flow chip is a consumable article of slide glass to which many micro reaction fields are fixed, and includes a fluid channel having an inlet port and an outlet port of reagent. 10 to 40 types of reagents such as enzymes required for base elongation reactions, nucleotides modified by multiple different fluorochromes, a reagent for decomposing a protecting group blocking elongation, and an imaging buffer filling a flow chip fluid channel during imaging are passed through the inlet port and the outlet port to the flow chip. A typical example of a micro reaction field explained here includes beads of 1 μm.

After a reagent is supplied, it may be necessary to control the temperature of the reagent in the flow chip in accordance with the type of the reagent in the fluid channel in the flow chip. This is necessary to advance the chemical reaction accurately and efficiently, and the flow chip is brought into close contact with an aluminum plate generally called a neat block, so that the temperature of the flow chip is adjusted within 10 to 80 degrees Celsius. The supply of the reagent and the temperature adjustment operation are advanced in a stepwise manner, and a fluorescent nucleotide for a single base can be retrieved into the DNA on the micro reaction field. Subsequently, optical measurement is performed. In general, one side of the flow chip is in close contact with the heat block that performs temperature adjustment, and therefore, an object lens is disposed at the other side of the flow chip. When an excitation light is emitted to the micro reaction field on the flow chip substrate via the object lens, fluorescence is emitted. This fluorescence is captured by a two-dimensional sensor such as a CMOS camera, so that fluorescence information about many micro reaction fields fixed on the flow chip substrate can be obtained as images.

Subsequently required is to move the measurement vision field of the flow chip with respect to the optical axis of the fixed object lens. More specifically, the heat block to which the flow chip is fixed is fixed to an XY stage, and the XY stage is driven for a certain distance, so that an adjacent panel is successively positioned on the optical axis. Accordingly, the flow chip peripheral portion is a portion where a component and an operation for controlling the reagent supply, the temperature control, the optical detection, and the stage drive are locally concentrated in a condensed manner. Therefore, it is necessary to prevent each component from, mechanically colliding and interfering with each other, and it is necessary to smoothly perform driving.

On the other hand, an application of a next-generation sequencer to diagnosis is rapidly advancing. One of important issues in expanding the next-generation sequencer technique in the diagnosis field includes a reduction of the diagnosis cost. Under such circumstances, the reduction of the cost of a flow chip which is a consumable article is a key to reduce the diagnosis cost. More specifically, the reduction in the size of the flow chip is the problem to be solved.

In order to solve the above problem, PTL 1 discloses a configuration in which a fluid channel is diverged in a flow chip, so that the inlet port and the outlet port are brought closer to each other in the fluid channel system. According to this configuration, the positions of the fluid channel connection components on the flow chip can be converged, so that the number of the positions of the fluid channel connection components on the flow chip can be reduced from two to one. Accordingly, this can reduce the number of portions where the object lens and the fluid channel connection unit interfere with each other, and realize a reduction in the size of the flow chip. More specifically, the size of the flow chip was 75 mm by 25 mm, but this is reduced to a size of 30 mm by 15 mm. Further, PTL 1 also describes a flow chip cartridge for holding a flow chip in view of operability of the flow chip.

On the other hand, an area of a flow chip that can be measured with a single image will be referred, to as a single panel. The size of a single flow chip is 30 mm by 15 mm, but as indicated by NPL 1, the number of panels measured is 14 panels. The size of a single panel is up to 0.75 mm by 0.75 mm according to liberal estimates, and therefore, the area used for the optical measurement is 10.5 mm by 0.75 mm. More specifically, only 2% of the area of the flow chip is actually used for the optical measurement. Therefore, the margin for further reducing the size of the flow chip is still large. In PTL 1, the reason why the fluid channel is caused to diverge is that the number of panels is limited to 12 by 1. More specifically, the panels are disposed only in one row direction, and the stage drive is limited to only the X direction, and so that the fluid channel is caused to diverse in the flow chip. In a case where the flow chip is configured to be driven in two directions of X and Y, the configuration for forming the diverging fluid channel cannot increase the size of the flow chip because of fluid channel walls. In the configuration for forming a diverging fluid channel, the fluid channel becomes complicated, and therefore, the cost increases. Therefore, the fluid channel diverging method of PTL 1 is effective only in a case where the number of panels is limited to about 10, and the throughput is limited, and the applicable application is limited to those having a low throughput.

The reason why a size of 30 mm is required in the longitudinal direction of the flow chip is the following reasons. It is necessary to install a heat block at one surface of the flow chip for temperature adjustment, and it is necessary to perform supply of a reagent and perform optical detection on the other surface of the flow chip. Therefore, in order to avoid mechanical interference between the object lens and the fluid channel connection unit of the flow chip, the size of the flow chip is required to be equal to more than a certain size. Therefore, in the past, it used to be difficult to reduce the size of the flow chip.

The index regarded as important in the next-generation sequence development is the throughput. The throughput is the total number of bases that can be input per run, and in order to increase this, techniques have been developed. In the past, the reaction field is randomly scattered and fixed on the flow chip substrate. However, the configuration of random fixing has several problems such as (1) since the reaction fields are close to each other at a certain chance, it is difficult to analyze reaction fields close to each other by resolution or more, and (2) since the distance between bright spots is random, the effect of crosstalk between bright spots is different for each bright spot, and there is a large variation in the detection accuracy. In order to cope with such problems, what attracts attention recently is a technique capable of arranging the reaction fields on a substrate in a matrix manner.

NPL 2 describes a technique for arranging aminosilane films on a silicon substrate in a matrix manner by using a semiconductor lithography technique, NPL 3 describes a method for arranging samples on a substrate in a matrix manner for a single molecule sequencer. According to the present technique, holes called nano apertures are formed on a glass substrate by using light lithography. The nano apertures are formed on a substrate regularly according to a semiconductor lithography technique. The diameter of the nano aperture is shorter than the wavelength, and therefore, the excitation light for exciting fluorescent single molecules fixed to the nano aperture cannot directly pass through the nano aperture. However, because of leaked light, only a very small area in proximity to the nano aperture can be illuminated. Because of this effect, the fluorochromes floating in a solution is prevented from being excited, and the excitation light can be emitted to only a small area to be detected. Accordingly, a single molecule real time sequence can be achieved. In the single molecule real time sequence, a vision filed is fixed during sequence reaction, and the reaction is captured continuously at a high speed with a frame rate of 100 Hz with a two-dimensional camera. Therefore, it is not necessary to replace the reagent in the reaction.

The technique for regularly arranging the reaction fields on the flow chip explained above greatly contributes to the increase of the throughput, and at the same time, the cost required for production of the substrate also increases. A conventional substrate used for random fixing does not require a lithography step, but in order to regularly arrange reaction fields on the substrate, a lithography step is required. This makes the increase in the cost of the flow chip, i.e., a consumable article, inevitable. Therefore, in this case, it is also necessary to avoid interference between the object lens and the fluid channel connection unit, and to avoid the increase in the cost because of the reduction in the size of the flow chip.

### CITATION LIST

### Patent Literature

PTL 1: US 2012/0270305 A1

### Non-Patent Literature

NPL 1: “MiSeq System User Guide”, Part #15027617, Rev. F, Illumina, Inc., November 2012, pages 8, 13

NPL 2: Science. 2010 Jan. 1; 327 (5961):78-81

NPL 3: Proc Natl Acad Sci USA. 2008 Jan. 29; 105 (4):1176-81

### SUMMARY OF INVENTION

### Technical Problem

In the conventional sequence measurement, it is necessary to install a heat block at one surface of the flow chip for temperature adjustment, and it is necessary to perform supply of a reagent and perform, optical detection on the other surface of the flow chip. Therefore, in order to avoid mechanical interference between the object lens and the fluid channel connection unit of the flow chip, the size of the flow chip is required to be equal to more than a certain size, and it used to be difficult to reduce the cost of the flow chip, which, is a consumable article.

It is an object of the present invention to provide an analysis device capable of reducing the size of a flow chip while avoiding mechanical interference between the object lens and the fluid channel connection unit of the flow chip.

### Solution to Problem

In order to achieve the above object, for example, a configuration described in claims is employed. The present application includes multiple means for solving the above problems, but if an example thereof is shown, an analysis device including a flow chip at least including a first substrate having light transparency and a second substrate having an inlet port and an outlet port for a fluid, a holding member for holding the flow chip, a fixing member where the holding member is disposed, and which comes into contact, with the second substrate of the flow chip, a fluid supply unit which supplies the fluid to the inlet port, and which discharges the fluid from the outlet port, an optical detection unit disposed at a side of the first substrate of the flow chip, and a drive unit driving the holding member in an XY direction is provided.

### Advantageous Effects of Invention

According to the present invention, the size of a flow chip can be reduced, and therefore, the cost required for the flow chip can be reduced.

Further features related to the present invention would be clarified from the description and the appended drawings of the present specification. The problems, configurations, and the effects other than the above would be clarified from the following explanation about the embodiments.

### BRIEF DESCRIPTION OF DRAWINGS

FIG. 1 is a figure illustrating a configuration of a flow chip having a fluid channel hole on a substrate back surface according to the present embodiment.

FIG. 2A is a figure for explaining an attachment method of a cartridge to a flow chip cartridge according to the present embodiment.

FIG. 2B is a figure for explaining an attachment method of a cartridge to a flow chip cartridge according to the present embodiment.

FIG. 2C is a figure for explaining an attachment method of a cartridge to a flow chip cartridge according to the present embodiment.

FIG. 2D is a figure for explaining an attachment method of a cartridge to a flow chip cartridge according to the present embodiment.

FIG. 3A is a figure illustrating a positional relationship of an object lens with respect to a flow chip according to the present embodiment.

FIG. 3B is a figure illustrating the flow chip according to the present embodiment when it is seen from a cover glass side.

FIG. 3C is a figure illustrating a positional relationship of an object lens with respect to a flow chip according to another example of the present embodiment.

FIG. 3D is a figure illustrating a flow chip of another example according to the present embodiment when it is seen from a cover glass side.

FIG. 4A is a figure illustrating a configuration of a temperature adjustment unit for fixing the flow chip according to the present embodiment.

FIG. 4B is a figure illustrating a configuration of a heat block according to the present embodiment.

FIG. 5A is a cross sectional diagram illustrating a configuration for fixing a flow chip cartridge to a temperature adjustment unit according to the present embodiment.

FIG. 5B is a cross sectional diagram illustrating another configuration for fixing a flow chip cartridge to a temperature adjustment unit according to the present embodiment.

FIG. 6A is a figure for explaining a fixing structure of a flow chip using a flow chip cover according to the present embodiment.

FIG. 6B is a figure for explaining a fixing structure of a flow chip using a flow chip cover according to the present embodiment.

FIG. 6C is a figure for explaining a fixing structure of a flow chip using a flow chip cover according to the present embodiment.

FIG. 7 is a figure for explaining another fixing structure of a flow chip using a flow chip cover according to the present embodiment.

FIG. 8 is a cross sectional diagram taken along A-A of FIG. 7.

FIG. 9 is an explanatory diagram, illustrating a sequence method using the flow chip according to the present embodiment.

FIG. 10 is a figure illustrating a configuration of a conventional flow chip.

FIG. 11A is a figure illustrating a positional relationship of an object lens with respect to a conventional flow chip.

FIG. 11B is a figure illustrating a conventional flow chip when it is seen from a cover glass side.

### DESCRIPTION OF EMBODIMENTS

Hereinafter, an embodiment of the present invention will be explained with reference to appended drawings. It should be noted that the appended drawings illustrate specific embodiments based on the principal of the present invention, but these are given for the sake of understanding of the present invention, and should not be used, for interpreting the present invention in a limited manner. The embodiment described below relates to an analysis device, and more specifically, the embodiment relates to a nucleic acid sequence analysis device for interpreting a base sequence of nucleic acid such as DNA or RNA.

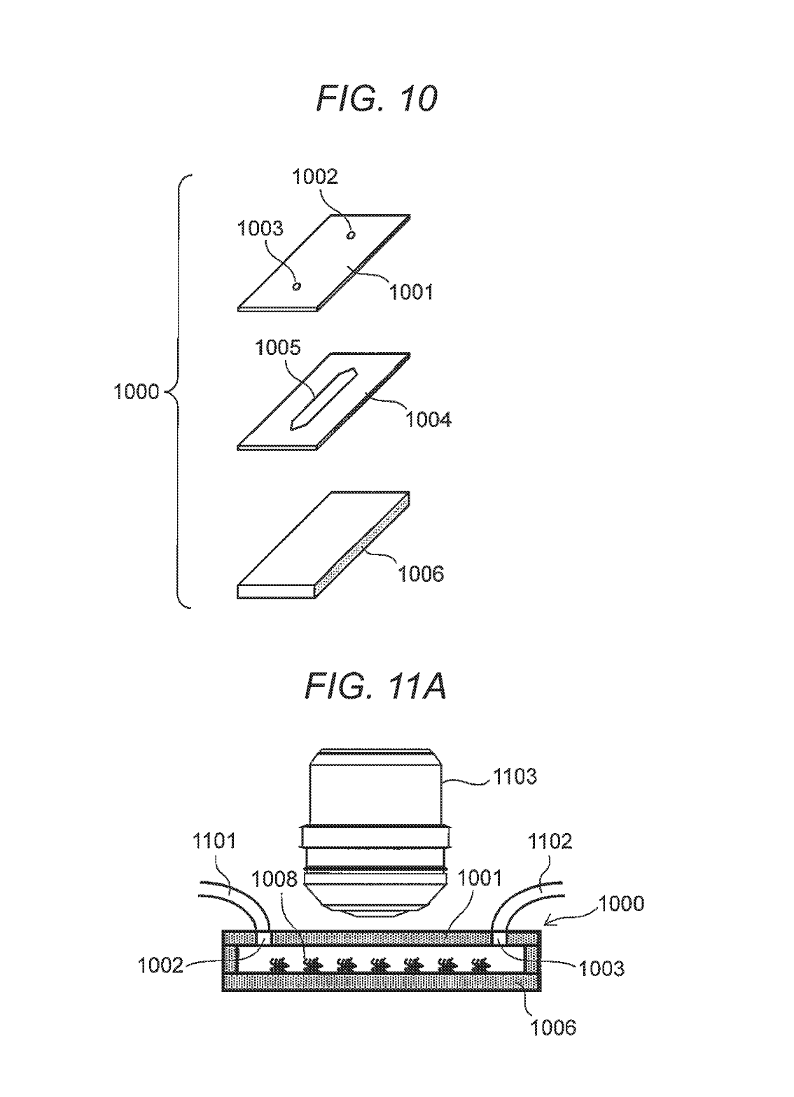

FIG. 10 is a figure illustrating a configuration of a conventional flow chip. A conventional flow chip 1000 is made by pasting three members, i.e., a cover glass 1001, a spacer 1004, and a substrate 1006, with each other. The cover glass 1001 includes an inlet port 1002 and an outlet port 1003 of a fluid channel. In general, the spacer 1004 is produced from a material such as PDMS. The thickness of the spacer 1004 is 30 to 100 μm, and more particularly, the thickness of the spacer 1004 is preferably 50 μm. The spacer 1004 has a penetration hole 1005 for forming a fluid channel when the three members are adhered to each other. The fluid channel is formed by sandwiching the spacer 1004 between the cover glass 1001 and the substrate 1006. A chemical modification is applied to the surface of the substrate 1006, so that DNA fragments can be joined efficiently. Typical methods of surface modification of the substrate 1006 include polylysine, aminosilane, or epoxy coating. Any of the methods is characterized in that positive electrical charge is provided with respect to a DNA molecule having an electrically negative electrical charge.

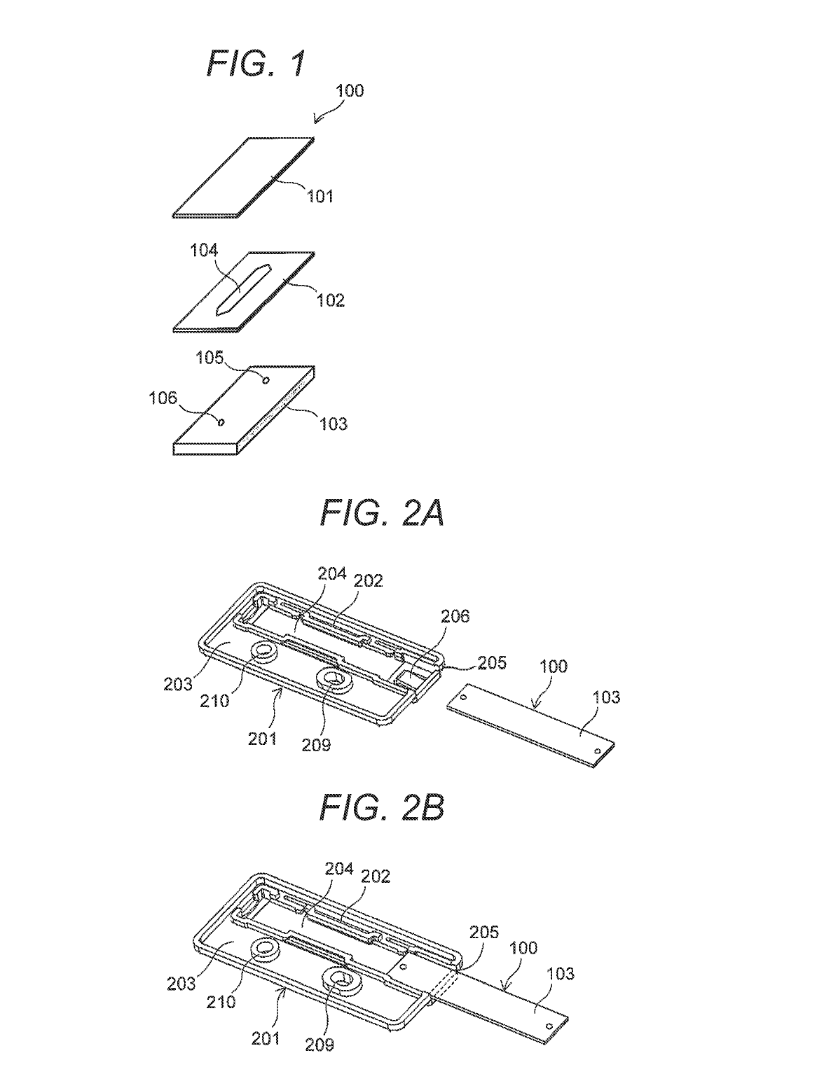

In contrast, FIG. 1 is a figure illustrating a configuration of a flow chip having a fluid channel hole on a substrate back surface according to the present embodiment. A flow chip 100 according to the present embodiment is made by pasting three members, i.e., a cover glass 101, a spacer 102, and a substrate 103 having optically transparent characteristics (optical transparency), with each other. The spacer 102 includes a penetration hole 104 for forming a fluid channel. The present invention is characterized in that the substrate 103 includes an inlet port 105 and an outlet port 106 of the fluid channel. The remaining configuration is the same as that of the conventional flow chip explained above.

The substrate 103 of the flow chip 100 is a silicon substrate, and the substrate 103 is formed with an absorption site capable of selecting absorbing DMA upon a semiconductor light lithography step. More specifically, the substrate 103 includes reaction portions in a matrix manner and in a regular manner with a regular interval upon a semiconductor light lithography step. The absorption site is bonded with, more specifically, aminosilane, polylysine, or epoxy capable of selectively being bonded with DNA. Alternatively, surface processing capable of selectively being bonded with DNA is applied in the absorption site.

According to this configuration, the size of the flow chip can be reduced. The specific size of the flow chip 100 according to the present embodiment will be explained later. It should be noted that FIG. 1 illustrates an example of forming a fluid channel by using the spacer 102, but the configuration is not limited thereto. For example, the flow chip may be made by pasting two members, i.e., a cover glass and a substrate, with each other. In this case, a fluid channel is made by forming a groove on any one of the cover glass and the substrate.

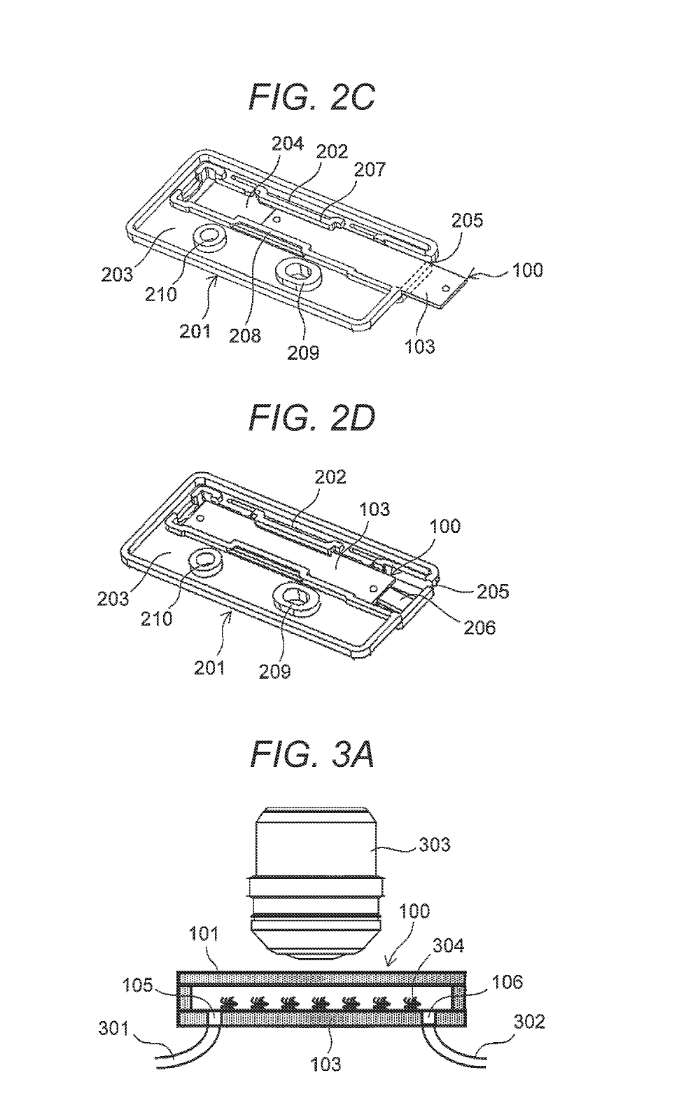

FIG. 2A to FIG. 2D are figures illustrating configurations of a cartridge for a flow chip according to the present embodiment, and is a figure illustrating the flow chip cartridge 201 when it is seen from a back direction. The flow chip cartridge 201 holds the flow chip 100 in order to improve the handling performance of the flow chip 100 of which size has been reduced. In this example, the size of the flow chip 100 is 50 mm wide, 10 mm long, and 0.9 mm thick.

As illustrated in FIG. 2A, the flow chip cartridge 201 has a substantially rectangular shape in a top view, and includes a chip holding unit 202 and a cartridge fixing unit 203. The chip holding unit 202 includes an aperture unit 204. With the aperture unit 204, a side of the flow chip 100 at the cover glass 101 is exposed to the optical detection system, and the substrate 103 of the flow chip 100 can be brought into contact with a temperature adjustment unit explained later. An insertion port 205 for the flow chip 100 is provided at an end portion of the flow chip cartridge 201 in the longitudinal direction. As illustrated in FIG. 2B, the flow chip 100 can be inserted through the insertion port 205 to the position of the aperture unit 204.

As illustrated in FIG. 2C, contact units 207, 208 are provided at the longer side of the aperture unit 204. When the flow chip 100 is further slid in the depth direction with respect to the flow chip cartridge 201, the contact units 207, 208 come into contact with the flow chip 100. For example, contact length of the contact units 207, 208 (an extension length to the side of the aperture unit 204) is 1 mm, and accordingly, the flow chip 100 can be held at the position of the aperture unit 204.

A claw unit 206 is provided at the position of the insertion port 205 of the flow chip cartridge 201. As illustrated in FIG. 2D, when the flow chip 100 is pushed to the end with respect to the flow chip cartridge 201, the claw unit 206 presses the end portion of the flow chip 100. Accordingly, the flow chip 100 is fixed. The size of the flow chip cartridge 201 is 65 mm by 30 nm, and therefore, workers can easily handle the flow chip 100. It should be noted that the cartridge fixing unit 203 is provided with a first hole 209 and a second hole 210. In this case, the first hole 209 is a long hole, and the second hole 210 is a circular hole. The first hole 209 and the second hole 210 are inserted into fixing pins of the heat block explained later, and are used to make accurate positioning of the flow chip cartridge 201.

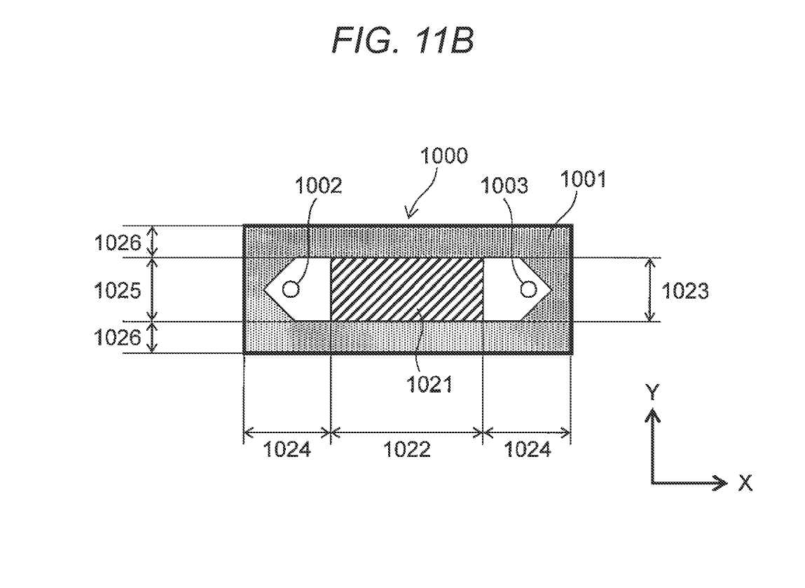

Subsequently, a positional relationship between an object lens and a flow chip having a fluid channel hole on a substrate back surface will be explained. First, a conventional configuration will be explained. FIG. 11A is a figure illustrating a positional relationship of an object lens with a conventional flow chip. FIG. 11B is a figure illustrating a conventional flow chip when it is seen from the side of the cover glass.

The cover glass 1001 of the flow chip 1000 includes an inlet port 1002 and an outlet port 1003 for reagent. A fluid channel is formed in the flow chip 1000. The inlet port 1002 and the outlet port 1003 are connected to tubes 1101, 1102, respectively. The silicon substrate 1006 of the flow chip 1000 is processed in surface processing to be able to selectively fix DNA upon a semiconductor lithography step. On the substrate 1006, DNBs 1008 which are amplification products of DNA can be disposed in a selectively manner and in a matrix manner with a pitch of 600 nm. The DNB 1008 are obtained by amplifying a target DNA in accordance with rolling circle amplification method, and has a spherical shape having a diameter of 300 nm.

Although not shown in the drawings, the flow chip 1000 is disposed on the heat block, and the temperature is adjusted in a range between 10 to 80 degrees Celsius. Further, a reagent is supplied via the tube 1101 to the inlet port 1002 of the cover glass 1001 of the flow chip 1000, and thereafter, the reagent is discharged through the outlet port 1003 via the tube 1102. Although not shown in the drawing, the heat block for holding the flow chip 1000 is fixed on the XY stage. Therefore, the flow chip 1000 and the tubes 1101, 1102 move relatively with respect to the object lens 1103. However, the tubes 1101, 1102 and the object lens 1103 may mechanically interfere according to driving of the XY stage. Therefore, the range in which the XY stage can be drive is limited to the range in which the tubes 1101, 1102 and the object lens 1103 interfere with each other. More specifically, as illustrated in FIG. 11B, an area in which fluorescent measurement can be actually performed in the flow chip 1000 is limited to an area 1021 indicated by diagonal lines. Therefore, in an area outside of the area 1021 of the flow chip 1000, the DNB sample is fixed, but the fluorescent measurement cannot be performed because of interference between the object lens 1103 and the tubes 1101, 1102. Therefore, in the conventional configuration, a DNB fixing area of the flow chip 1000 cannot be effectively used.

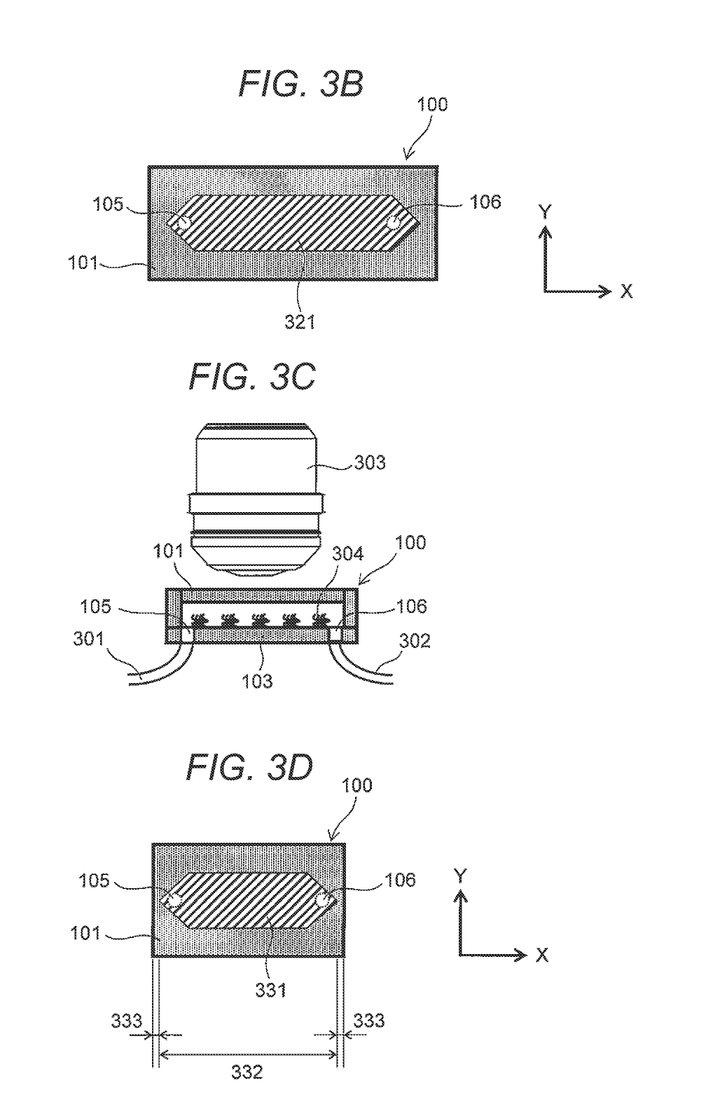

FIG. 3A is a figure illustrating a positional relationship of an object lens with respect to a flow chip according to the present embodiment. FIG. 3B is a figure illustrating a flow chip according to the present embodiment when it is seen from, the side of the cover glass. As described above, the substrate 103 at the lower surface of the flow chip 100 includes an inlet port 105 and an outlet port 106 of a fluid channel. The inlet port 105 and the outlet port 106 are connected to tubes 301, 302, respectively. An object lens 303 is disposed above the cover glass 101 of the flow chip 100. Therefore, a mechanical interference between the object lens and the tube, like those that occurs in the conventional configuration (FIG. 11A), does not occur. As illustrated in FIG. 3B, in the flow chip 100 according to the present embodiment, an area in which, fluorescent measurement can be actually performed is an area 321 indicated by diagonal lines. Therefore, there is an advantage in that even when a flow chip of the same size as a conventional one is used, the area in which the measurement can be performed is expanded, and the throughput can be increased. This also substantially reduces the cost of the flow chip.

FIG. 3C is a figure illustrating a positional relationship of an object, lens with respect to a flow chip according to another example of the present embodiment. FIG. 3D is a figure illustrating a flow chip when it is seen from the side of the cover glass according to another example of the present embodiment. In examples of FIG. 3C and FIG. 3D, the size of the flow chip 100 is further reduced. As described above, the substrate 103 at the lower surface of the flow chip 100 includes an inlet port 105 and an outlet port 106 for a fluid channel. The inlet port 105 and the outlet port 106 are connected to the tubes 301, 302, respectively. The object lens 303 is disposed above the cover glass 101 of the flow chip 100. Accordingly, a mechanical interference between the tubes 301, 302 and the object lens 303 can be prevented. Therefore, while the size of the area 331 in which the fluorescent measurement can be performed is caused to be the same as the area 1021 of FIG. 11B, the size of the flow chip 100 can be reduced to be smaller than the conventional flow chip 1000 (FIG. 11B). Therefore, the cost can be reduced by reducing the size of the flow chip 100.

In this case, in FIG. 11A and FIG. 11B, the size of the area 1021 in which the DNBs 1008 are fixed is 40 mm by 5 mm. More specifically, in FIG. 11B, a length 1022 is 40 mm, and a length 1023 is 5 mm. In FIG. 11A and FIG. 11B, it is necessary to increase the size of the flow chip 1000 in order to avoid an interface between the object lens 1103 and the tubes 1101, 1102. A length 1024 required for the connection portion of the tubes 1101, 1102 is 21 mm. Therefore, the size of the flow chip 1000 in the X direction is 40 mm+21 mm*2=82 mm. It is not necessary to consider the connection of the tube in the Y direction, and therefore, a length 1025 is 5 mm, and a length 1026 is 2.5 mm. Therefore, the length of the flow chip 1000 in the Y direction is 5 mm+2.5 mm*2=10 mm.

In FIG. 3C and FIG. 3D, although a length 332 of the area in which the DNBs 304 are fixed is 40 mm, a length 333 is 5 mm. Therefore, a length of the flow chip in the Y direction is 40 mm+5 mm*2=50 mm. Therefore, by avoiding an interference between fluid channel connection units (the tubes 301, 302) and an object lens 303, the size of the flow chip 100 can be reduced to a size of 50 mm/82 mm≈60%. This brings an effect of reducing the cost of the flow chip 100 to 60%.

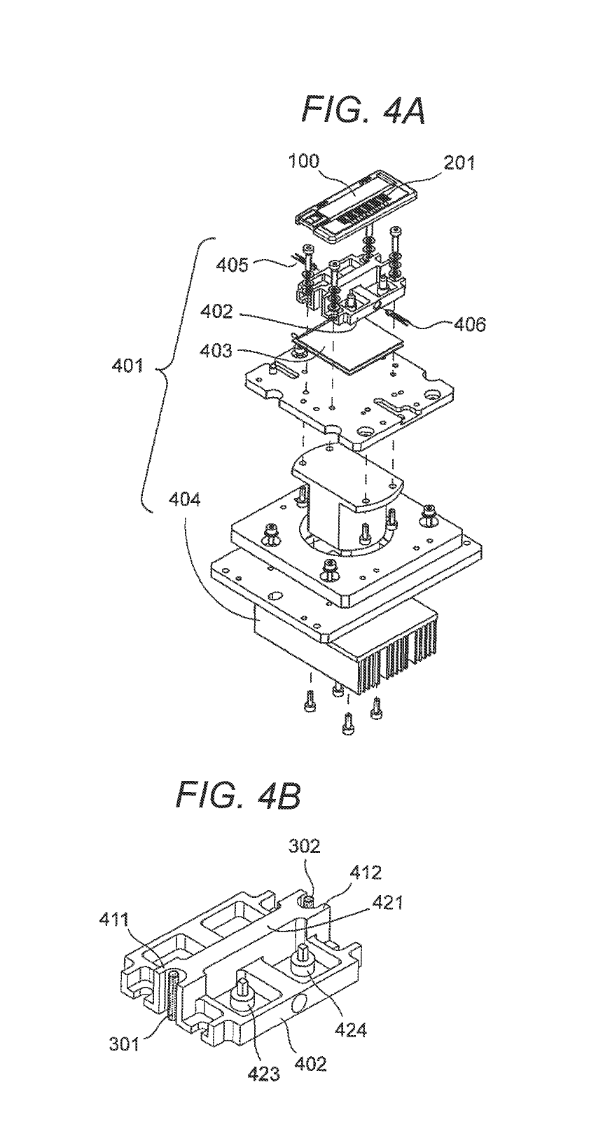

Subsequently, the detailed shape of the heat block for fixing the flow chip 100 having the fluid channel hole on the substrate back surface will be explained. FIG. 4A is a figure illustrating a configuration of a temperature adjustment unit for fixing the flow chip 100.

A bar code label is adhered to the flow chip cartridge 201 of FIG. 4A, and accordingly, management in terms of experiment, inventory management, management of usable period management, and the like of the flow chip 100 are performed. It should be noted that the bar code label may be an electric tag such as RFID.

The flow chip cartridge 201 holding the flow chip 100 is fixed to a temperature adjustment unit 401. The temperature adjustment unit 401 has a role of fixing the flow chip cartridge 201 and performing temperature control of the reagent in the fluid channel of the flow chip 100. The temperature adjustment unit 401 includes at least a heat block 402, a Peltier device 403, and a heat sink 404. The flow chip cartridge 201 is fixed to the neat block 402. The Peltier device 403 is disposed under the heat block 402.

Temperature sensors 405, 406 are inserted into the heat block 402 to monitor the temperature of the heat block 402. With the temperature sensors 405, 406, PID control is performed to a predetermined temperature, so that the temperature of the heat block 402 can be caused to be at the predetermined temperature. With this configuration, the reagent supplied into the flow chip 100 at the predetermined temperature within a range of 10 to 80 degrees Celsius can be caused to be at the temperature adjustment.

In order to discharge the heat generated by the Peltier device 403, the heat sink 404 is disposed under the Peltier device 403. A fan, not shown, is used to below air to the heat sink 404, so that the heat is discharged from the heat sink 404. Accordingly, the heat generated by the Peltier device 403 is swiftly discharged, and a temperature difference ΔT between the front and the back of the Peltier device 403 can be reduced. This has an effect of improving the heat transfer efficiency possessed by the Peltier device 403, and as a result, a high ramp rate can be realized. As illustrated in FIG. 4A, multiple members for fixing the heat block 402, the Peltier device 403, and the heat sink 404 may be interposed between the Peltier device 403 and the heat sink 404.

FIG. 4B is a figure illustrating a configuration of a heat block. The heat block for fixing the flow chip 100 having the inlet port 105 and the outlet port 106 of the reagent on the substrate 103 will be explained. The heat block 402 is provided with the substrate 103 of the flow chip 100 at the position corresponding to the flow chip 100, and has an installation unit 421 that comes close contact with the substrate 103. Notch units 411, 412 are formed at both ends of the installation unit 421 of the heat block 402. The notch units 411, 412 are provided at the positions corresponding to the inlet port 105 and the outlet port 106, respectively, of the substrate 103. Therefore, the tubes 301, 302 are inserted from the lower side of the notch units 411, 412, so that the tubes 301, 302 can be connected to the inlet port 105 and the outlet port 106 of the substrate 103 of the flow chip 100. Therefore, the object lens 303 and the tubes 301, 302 at the upper surface side of the flow chip 100 would not mechanically interfere with each other. Therefore, as described above, size of the flow chip 100 can be reduced, and the cost of the flow chip 100, i.e., a consumable article, can be reduced. On the surface of the substrate 103 of the flow chip 100 coming into contact with the neat block 402, the temperature adjustment is performed with an accuracy of +0.5 degrees Celsius, and the chemical reaction can be advanced accurately.

The heat block 4 02 according to the present embodiment is provided with fixing pins 423, 424 at the positions of the first hole 209 and the second hole 210 of the flow chip cartridge 201, and the fixing pins 423, 424 are attached to the heat block 402 according to a method such as press fitting. Therefore, when the flow chip cartridge 201 is fixed to the heat block 402, the fixing pins 423, 424 facilitate the positioning of the flow chip cartridge 201. The present embodiment illustrates a configuration for fixing the flow chip cartridge 201 for holding the flow chip 100 to the temperature adjustment unit 401, but the present embodiment is not limited to this example. For example, depending on the type of the reagent, the temperature adjustment unit may not be necessary. Therefore, in such case, instead of the temperature adjustment unit 401, a fixing member for fixing the flow chip cartridge 201 may be provided. This fixing member may have a fixing pin and the like just like what has been described above.

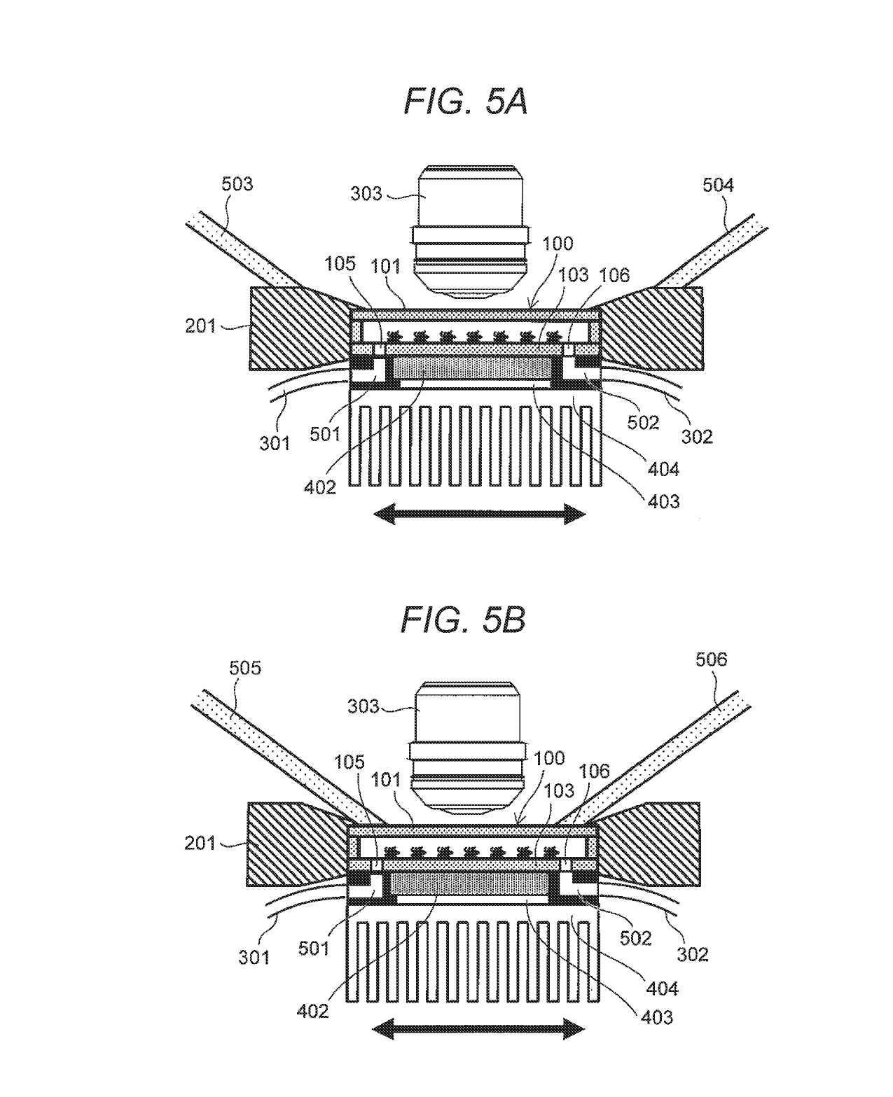

Subsequently, a fixing method for fixing the flow chip 100 having the inlet port 105 and the outlet port 106 of the reagent on the substrate 103 to the neat block will be explained. FIG. 5A is a cross sectional view illustrating a configuration for fixing the flow chip cartridge 201 to the temperature adjustment unit. While the flow chip 100 is held on the flow chip cartridge 201, the flow chip 100 is in contact with the heat block 402. A length required by the flow chip cartridge 201 to hold the flow chip 100 is 1 mm, and the contact units 207, 208 (see FIG. 2C) of the flow chip cartridge 201 holds an edge area for 1 mm from the external periphery of the flow chip 100. The DNBs which is the amplification products of the DNA are disposed in a lattice form in a regular manner on the silicon substrate 103 which is the lower surface of the flow chip 100.

The Peltier device 403 is disposed immediately under the heat block 4 02, and further, the heat sink 404 is disposed below the Peltier device 403. In the example of FIG. 5A, resin members 501, 502 are disposed at the positions of the notch units (411, 412 of FIG. 4B) of the heat block 402. Each of the resin members 501, 502 is provided with a fluid channel, and the fluid channels of the resin members 501, 502 are connected to the inlet port 105 and the outlet port 106 of the substrate 103. The fluid channels of the resin members 501, 502 are connected to tubes 301, 302, respectively.

The flow chip cartridge 201 is pressurized in the lower direction by flow chip clamps 503, 504, so that the flow chip 100 is in close contact with the heat block 402. Accordingly, the flow chip 100 is brought into close contact with the heat block 402, and a preferable temperature control can be performed with the temperature adjustment unit 401. Since FIG. 5A is a cross sectional diagram, only two flow chip clamps 503, 504 are drawn, but as explained later, there may be four flow chip clamps may be provided to press the four corners of the flow chip cartridge 201 downward. The flow chip clamps 503, 504 presses the flow chip cartridge 201 holding the flow chip 100, so that the flow chip 100 can be indirectly brought into close contact with the heat block 402.

FIG. 5B is a cross sectional view illustrating another configuration for fixing the flow chip cartridge 201 to the temperature adjustment unit. In this example, the flow chip clamps 505, 506 directly press the four corners of the flow chip 100, so that the flow chip 100 can be brought into close contact with the heat block 402. In this example, as compared with the configuration of FIG. 5A, the flow chip 100 can be more reliably pressed against the heat block 402, and therefore, there is an advantage in that the risk of liquid leakage from the fluid channel can be reduced, and the temperature adjustment performance can be performed more reliably. Together with the configuration of FIG. 5A and FIG. 5B, the object lens 303 is disposed on one surface of the flow chip 100, and the fluid channel connection unit is disposed on the other surface, so that there is an advantage in that the mechanical interference of them both can be avoided. Further, there is an advantage in that the size of the flow chip 100 can be reduced, and the cost of the flow chip 100 is reduced. It should be noted that a configuration may be employed to press both end portions of the flow chip 100 or the flow chip cartridge 201 in the longitudinal direction by using two flow chip clamps. Therefore, in order to press the flow chip 100 or the flow chip cartridge 201, at least two flow chip clamps may be provided.

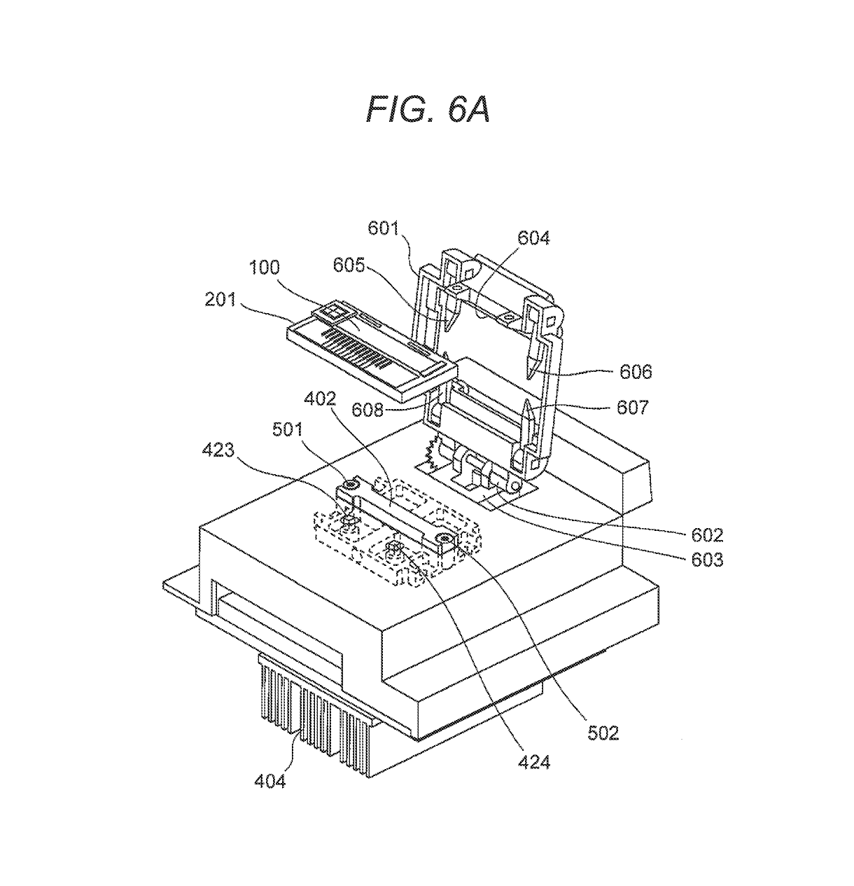

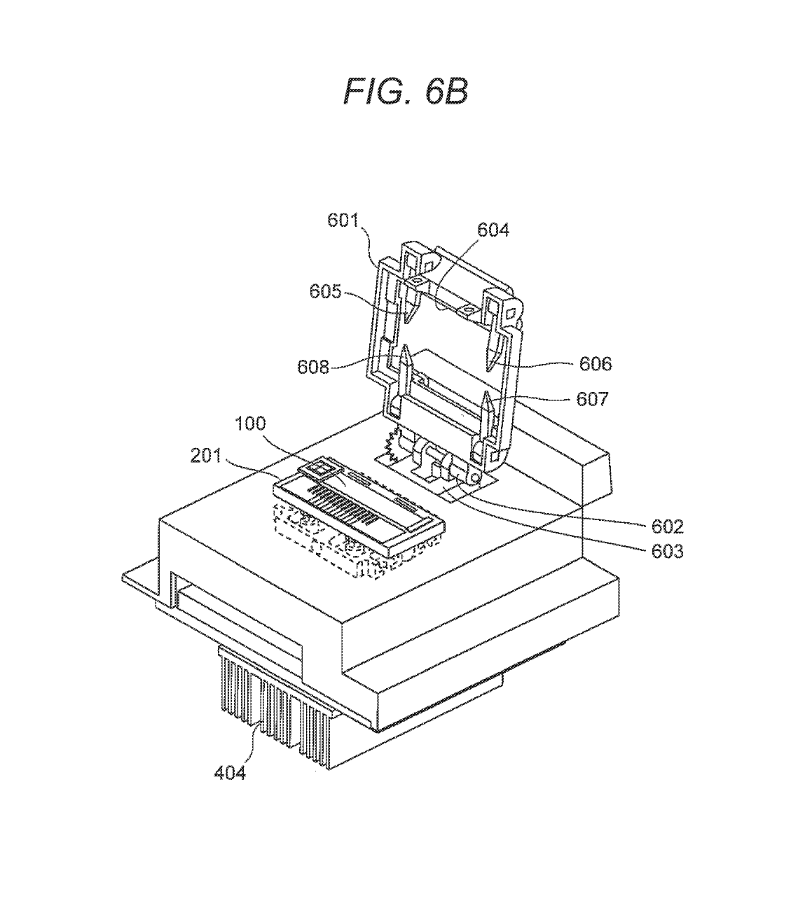

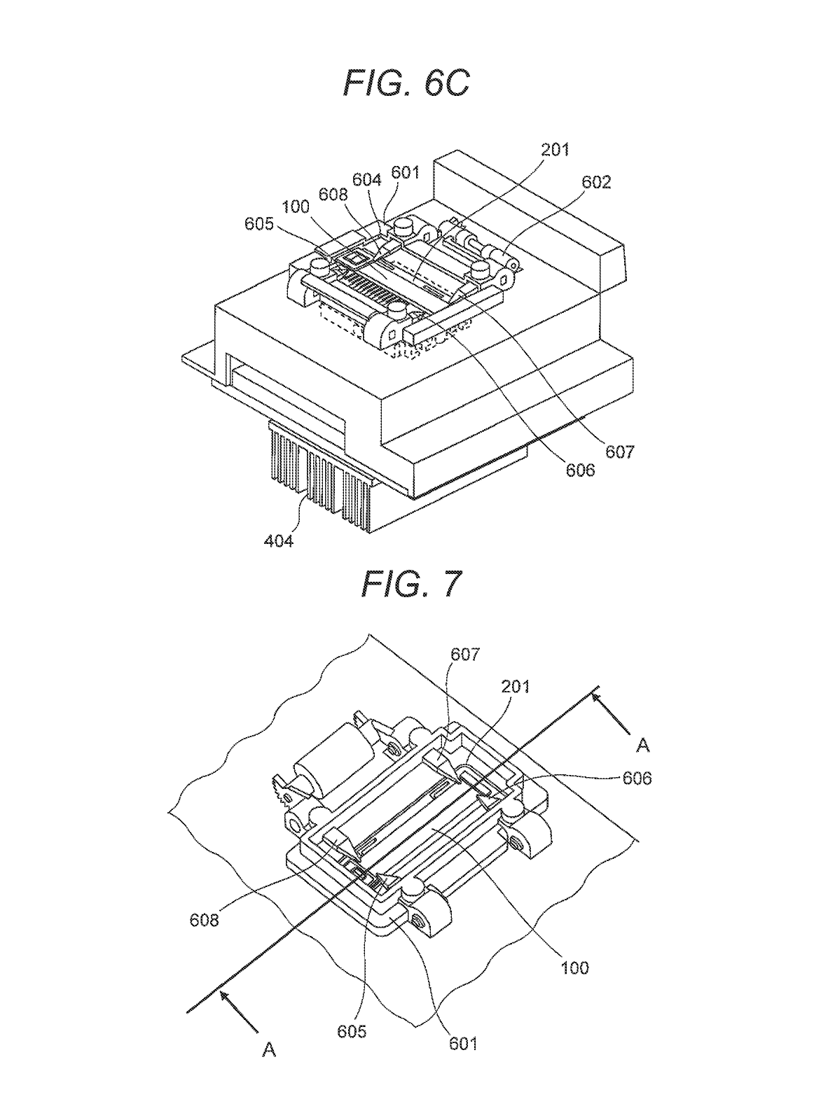

Subsequently, a fixing method of a flow chip using a flow chip cover will be explained. FIG. 6A to FIG. 6C are figures illustrating a configuration of a flow chip cover according to the present embodiment. A flow chip clamp cover 601 is attached to a structure 603 installed on the flow chip cartridge 201 with a rotation shaft 602. The flow chip clamp cover 601 includes an aperture unit 604. Flow chip clamps 605, 606, 607, 608 are provided at the four corners of the aperture unit 604. The flow chip clamps 605, 606, 607, 608 are formed to protrude to the inner side from the external periphery of the aperture unit 604, and have a tapered shape.

The notch unit of the heat block 402 is provided with resin members 501, 502 formed with fluid channels. The flow chip 100 having the inlet port 105 and the outlet port 106 on the substrate 103 is disposed on the heat block 402, so that the fluid channels are formed. O-rings are provided on the inlet port and the outlet port of the resin members 501, 502, and the flow chip 100 is pressurized from the upper side, so that the fluid channels that do not cause any liquid leakage can be formed. As described above, the heat block 402 is provided with the fixing pins 423, 424. As illustrated in FIG. 6B, the first hole 209 and the second hole 210 of the flow chip cartridge 201 are inserted into the fixing pins 423, 424, so that the flow chip cartridge 201 is fixed to the heat block 402. According to this configuration, the flow chip 100 can be installed on the heat block 402 accurately without making a mistake in the installation direction of the flow chip 100.

As illustrated in FIG. 6C, after the flow chip cartridge 201 is installed on the heat block 402, the flow chip clamp cover 601 is rotated around the rotation shaft 602. When the rotation of the flow chip clamp cover 601 is finished, the flow chip clamps 605, 606, 607, 608 presses the four corners of the flow chip cartridge 201. Since the flow chip clamp cover 601 has the aperture unit 604, excitation light can be emitted to the micro reaction field on the substrate 103 of the flow chip 100 from the object lens 303 above the flow chip 100 with the aperture unit 604.

FIG. 7 is a figure for explaining another fixing structure of a flow chip using a flow chip cover according to the present embodiment. In the example of FIG. 7, the flow chip clamps 605, 606, 607, 608 of the flow chip clamp cover 601 presses the four corners of the flow chip 100, so that the flow chip 100 is held. The size of the flow chip 100 is 50 mm by 10 mm. Therefore, the flow chip 100 comes into close contact with the heat block 402, so that a preferable temperature adjustment and a fluid channel unit not causing any leakage can be formed.

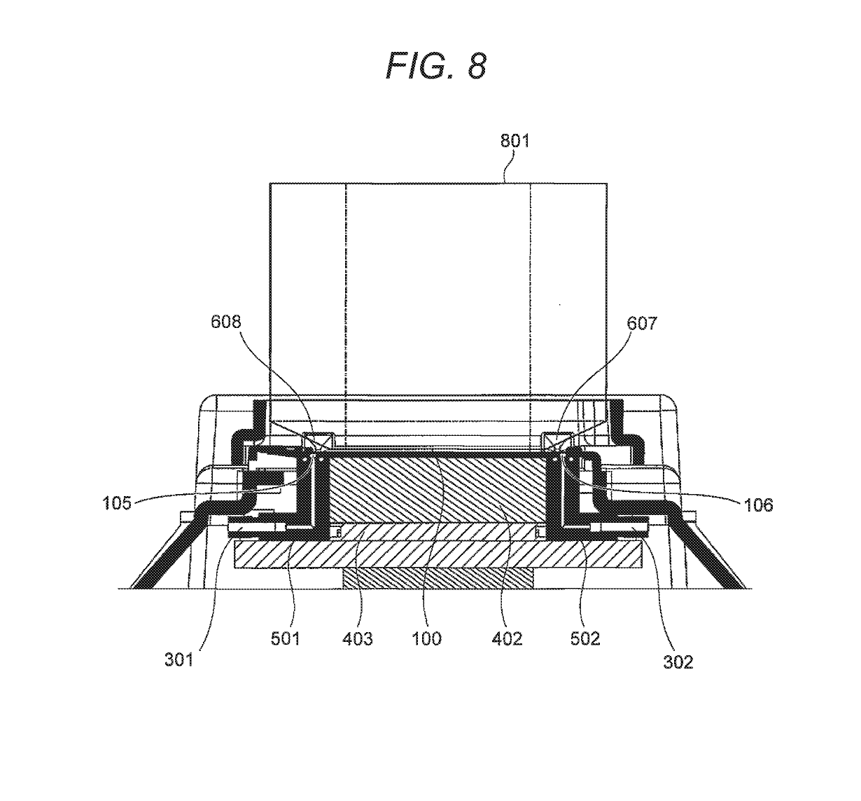

FIG. 8 is a cross sectional diagram taken along A-A of FIG. 7. When focused, the object lens comes into proximity with the cover glass 101 at the upper surface of the flow chip 100 with a distance of 0.6 mm. Reference symbol 801 of FIG. 8 indicates a relative drivable area of the object lens in a case where an XY stage, not shown, performs positioning of a fluorescent detection area 35 mm by 4 mm on the flow chip 100. The resin members 501, 502 are disposed in the notch units of the heat block 402, and fluid channels are formed therein. The resin employed here is ideally PEEK having a high degree of heat insulation effect and having a high degree of machinability for forming a fluid channel.

In FIG. 8, the flow chip 100 is pressed downward by flow chip clamps 605, 606, 607, 608, and is in close contact with the heat block 402. The Peltier device 403 adjusts the temperature of the flow chip 100 via the heat block 402. The fluid channels are formed in the resin members 501, 502 made of PEEK, and the fluid channels of the resin members 501, 502 are connected to the tubes 301, 302, respectively. O-rings are provided between the flow chip 100 and the fluid channels of the resin members 501, 502, and when pressurized with the flow chip clamps 605, 606, 607, 608, the O-rings are deformed to seal the fluid channels, so that liquid leakage from the fluid channels is prevented.

As described above, the drivable area 801 of the object lens schematically illustrates a range in which the object lens moves relatively with respect to the flow chip 100 when the XY stage is driven. When the peripheral portion of the flow chip 100 is explained, the flow chip clamps 605, 606, 607, 608 are disposed on the upper surface of the flow chip 100, and the heat block 402 and fluid channel connection units (the connection units with the tubes 301, 302) are disposed on the lower surface of the flow chip 100. As illustrated in FIG. 8, the components for the fixing structure of the flow chip, the temperature adjustment unit, the liquid supply structure, the optical measurement system., and the drive structure of the flow chip are concentrated around the flow chip 100. In view of the concentration, of these components, it is a problem to reduce the size of the flow chip 100 and improve the throughput. According to the present embodiment, in the structure of such concentrated components, the size of the flow chip 100 can be reduced as compared with a conventional case, and the cost can be reduced. According to the flow chip of the present embodiment, there is an advantage in that the area in which the measurement can be performed is expanded, and the throughput can increased.

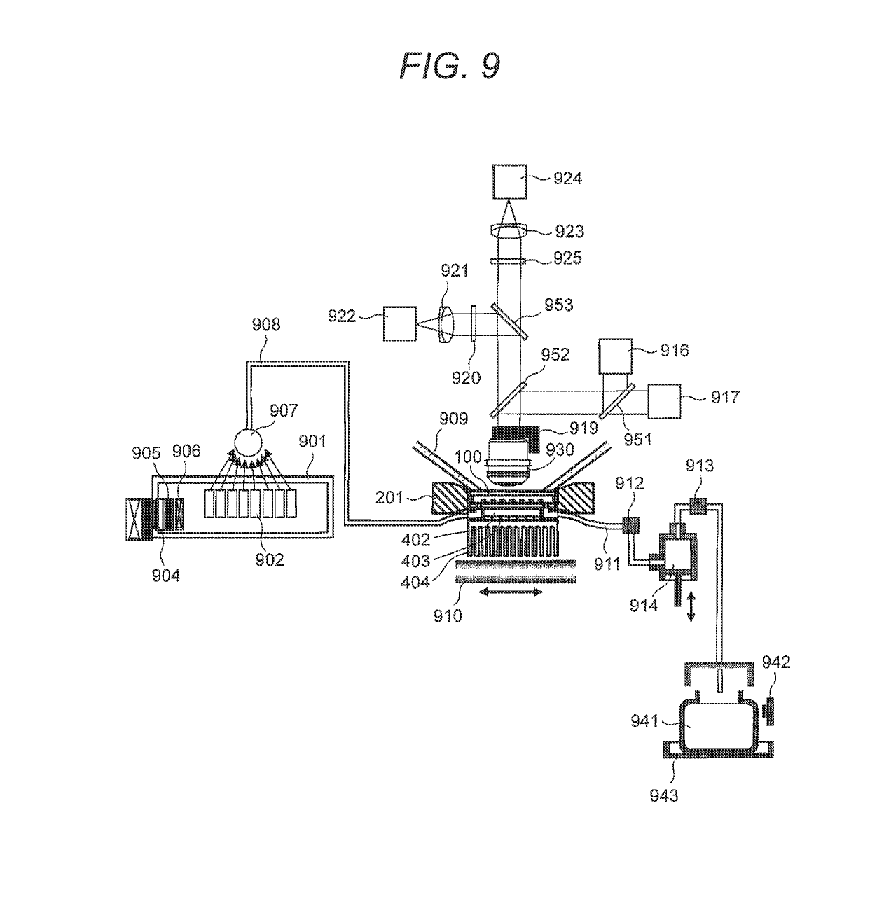

FIG. 9 is a figure illustrating a sequence method using a flow chip according to the present embodiment. First, the flow chip cartridge 201 is pressed by the flow chip clamp 909, so that the flow chip 100 is fixed to the heat block 402. The Peltier device 403 is disposed on the lower surface of the heat block 402, and the temperature of the flow chip 100 is adjusted. The temperature control range is 10 to 80 degrees Celsius. The temperature control is required for dissociation and the like of a primer serving as a basis of elongation and base elongation caused by enzyme reaction in a flow cell. Inside of the heat block 402, a temperature measurement resistor body (not shown) is disposed as a temperature sensor, and is used for feedback of the temperature control. The heat sink 404 comes into contact with the Peltier device 403, and discharges heat generated by driving of the Peltier device 403. The heat radiation from, the heat sink 404 is achieved by blowing air using a fan (not shown) to the heat sink 404.

The flow chip 100 and a structure for holding the flow chip 100 (the flow chip cartridge 201 and the like) is held on an XY stage (drive mechanism) 910. The XY stage 910 moves the flow chip 100 in a horizontal direction (XY direction) with respect to the object lens 930. The object lens 930 is fixed on a Z stage 919, and can move up and down in order to focus on the micro reaction field fixed to the flow chip 100. The object lens 930 is usually air gap, but it may also be possible to employ a method for filling pure water between the flow chip 100 and the object lens 930.

Reagents such as enzyme, four types of fluorescent reagents, buffer, nucleotide, cleaning fluid, and the like are disposed on a reagent cartridge 902. The reagent cartridge 902 in installed on the reagent rack 901, and is cooled to 4 degrees Celsius. A Peltier device 905 cools a heat block 904, and a fan 906 blow air in the reagent rack 901 to the heat block 904. The cooled air is circulated in the reagent rack 901, and the reagent 903 is indirectly cooled to 4 degrees Celsius.

Subsequently, fluid supply means for supplying reagent held on the reagent cartridge 902 to the inlet port 105 of the flow chip 100 and discharging the reagent from the outlet port 106 will be explained. The fluid supply means includes at least one syringe and multiple valves. The switch valve 907 can switch the fluid channel of the reagent held on the reagent cartridge 902. Accordingly, any given reagent can be introduced to the fluid channel. After the fluid channel is formed, the reagent passes through the fluid channel 908, and the reagent is supplied to the flow chip 100 holding the micro reaction field. Suction is performed by driving of a syringe 914 disposed on a downstream fluid channel 911. On the fluid channel 911, two two way valves 912, 913 are disposed. When the reagent is sucked, the syringe 914 is driven while the two way valve 912 is caused to be in an open state, and the two way valve 913 is caused to be in a closed state. In a case where reagent is supplied to a waste fluid tank 941, the syringe 914 is driven while the two way valve 912 is caused to be in a closed state, and the two way valve 913 is caused to be in an open state. With this operation, the supply of multiple reagents can be done with a single syringe 914.

The reagent having become waste fluid is passed to the waste fluid tank 941. In a case where there is no waste fluid tank 941, the waste fluid is spilled into the device, and there occurs a problem in that an electric shock, rust of the device, and occurrence of a foul smell, and the like. In order to avoid this, it is always necessary to arrange the waste fluid tank 941 in the device, and for this purpose, a micro photo sensor 942 for monitoring whether there is a waste fluid tank 941 or not is installed. In a case where the waste fluid leaks, a liquid reception tray 943 is installed under the waste fluid tank 941.

Elongation reaction of a DNA strand is performed by causing reaction of four types of nucleotides and polymerases labelled with different fluorochrome on the flow chip. The nucleotides are FAM-dCTP, Cy3-dATP, Texas Red-dGTP, and Cy5-dTsTP. The concentration of each nucleotide is 200 nM. The salt concentration, the magnesium concentration, and pH of the reaction liquid are optimized so that the elongation reaction is performed efficiently. The reaction solution includes polymerase, and a single base of fluorescent nucleotide complementary to the DNA fragment is retrieved. The reason why no elongation occurs in the second base is that a substance blocking elongation of the pigment of the second base is bonded with the fluorochrome of the first base. After the first base is retrieved, floating fluorescent nucleotide is removed by cleaning, and thereafter, fluorescent measurement is performed. In order to perform reaction of the minimum unit thereafter, a step of cleaving fluorochrome from the base with a dissociation solution and a step of cleaving an elongation blocking substance are required after the fluorescent measurement. With this step, a subsequent base elongation reaction can be continued successively. The fluorescent nucleotide is supplied into the flow cell again, and the reaction is repeated, so that a successive sequence is enabled. The reaction method employed in the present embodiment is called Sequence By Synthesis (SBS).

The optical detection system is arranged at the side of the cover glass 101 of the flow chip 100. In the following embodiment, the optical detection system will be explained in such a manner that the optical detection system is an incident-light fluorescence microscope, and includes LEDs, an optical filter, and a two-dimensional camera. Two LEDs 916, 917 are light sources for exciting fluorochrome. The center wavelengths of the LEDs 916 and 917 are 490 nm, 595 nm, respectively. The LED 916 is used for emission of excitation light of FAM-dCTP, Cy3-dATP, and the LED 917 is used for emission of excitation light of Texas Red-dGTP, Cy5-dTsTP. The dichroic mirror 951 aligns the light from the LEDs 916, 917 onto the same optical axis. Further, the excitation light is caused by the dichroic mirror 952 to be incident on the pupil plane of the object lens 930. The excitation light is emitted onto the fluorochrome retrieved into the micro reaction field in the flow chip 100 via the object lens 930, and the fluorochrome emits fluorescence. Apart of fluorescence emitted isotopically is collected by the object lens 930.

The light having passed through the object lens 930 is made into parallel light, and goes straight to the dichroic mirror 953 to be divided. The dichroic mirror 953 has gentle reflection characteristics for fluorescent wavelength areas in four colors. Therefore, on the light reception surfaces of CMOS cameras 922, 924, fluorescence intensity ratios of the bright spots emitted from the reaction fields on the flow chip 100 can be calculated. When the ratios on the imaging surface between two CMOS cameras 922, 924 are derived, it is possible to determine which of the four colors the light emission point belongs to. It should be noted that the parallel lights divided by the dichroic mirror 953 pass through emission filters 920, 925, respectively, and thereafter, the parallel lights are condensed by tube lenses 921, 923, and images are formed on the light reception surfaces of the CMOS cameras 922, 924.

According to the above configuration, the reagent is supplied into the flow chip 100, and with the temperature adjustment, the fluorescent nucleotide is caused to be retrieved, base by base, with polymerase on the micro reaction field, and elongation reaction is performed. The detection of the retrieved fluorochrome is recognized as an image, and this is applied to an adjacent panel, so that a large amount of base sequence information can be obtained. Thereafter, the fluorochrome is cleaved with a cleavage reagent, and the inside of the flow chip 100 is cleaned with a cleaning fluid, and thereafter, reagent including fluorescent nucleotide and polymerase is supplied again into the flow chip 100. These operations are performed for the required base length, so that base sequence analysis of DNA can be obtained.

In this device, the reaction reagent can be freely supplied in the flow chip 100 by driving the syringe 914 in the fluid channel forward direction and backward direction. At this occasion, the fluid channel is connected to the reagent tube filled with air by the switch valve 907. More specifically, the reagent in the flow chip 100 can be swung back and forth in the fluid channel. Accordingly, this can increase the collision reaction frequency of reagent molecules and DNBs fixed on the substrate surface in the flow chip 100, and can improve the reaction efficiency. Therefore, the reaction time can be shortened. Further, in this device, the DNB which is a sample is directly supplied within the device to the flow chip 100, and can be fixed. Accordingly, the fixing processing for fixing the DNB to the flow chip, which is performed outside of the device as a preprocessing in the past, can also be reduced.

In the above explanation, the reaction method of SBS has been explained, but another reaction method may be employed. For example, the supplied reagent includes oligomer modified by multiple fluorochromes, ligase for adding oligomer to DNA base, cleaning reagent, image obtaining reagent, and protecting group dissociation reagent, and the reaction method may be a sequence by ligation (SBL).

According to the embodiment of the present invention explained above, on the surface (the substrate 103) of the flow chip 100 at the opposite side to the surface where the object lens 303 is disposed with respect to the flow chip 100, the inlet port 105 and the outlet port 106 of the reagent of the flow chip 100 is provided. The shape of the heat block 4 02 for performing the temperature adjustment of the flow chip 100 is optimized, and is optimized into a heat block shape that enables the reagent to be injected and discharged from the direction of the surface where the temperature of the flow chip 100 is adjusted. Accordingly, a mechanical interference between the object lens 303 and the fluid channel connection unit of the flow chip 100 can be avoided. As a result, the size of the flow chip 100 can be reduced, and the cost can be reduced.

The present invention is not limited to the above embodiment, and includes various modifications. The above embodiment has been explained in details in order to explain the present invention in an easy to understand manner, and is not necessarily limited to those having all of the above configurations explained above. Some of the elements of any given embodiment may be replaced with elements of another embodiment. Elements of another embodiment may be added to elements of any given embodiment. With regard to some of the elements of each embodiment, other elements can be added, deleted, or replaced.

### REFERENCE SIGNS LIST

100: flow chip
101: cover glass
102: spacer
103: substrate
105: inlet port
106: outlet port
201: flow chip cartridge
202: chip holding unit
203: cartridge fixing unit
204: aperture unit
205: insertion port
206: claw unit
207, 208: contact unit
209: first hole
210: second hole
301, 302: tube
303: object lens
401: temperature adjustment unit
402: heat block
403: Peltier device
404: heat sink
405, 406: temperature sensor
406: temperature sensor
411, 412: notch unit

0 421: installation unit
423, 424: fixing pin
501, 502: resin member
503, 504, 505, 506: flow chip clamp
601: flow chip clamp cover
602: rotation shaft
603: structure
604: aperture unit
605, 606, 607, 608: flow chip clamp
901: reagent rack
902: reagent cartridge
903: reagent
904: heat block
906: fan
907: switch valve
908: fluid channel
909: flow chip clamp
910: XY stage
911: fluid channel
912, 913: two way valve
914: syringe
916, 917: LED
919: Z stage
920, 925: emission filter
921, 923: tube lens
922, 924: CMOS camera
930: object lens
941: waste fluid tank
942: microphotograph sensor
943: liquid reception tray
951, 952, 953: dichroic mirror

1.-15. (canceled)

16. An analysis device comprising:
a flow chip at least including a first substrate having light transparency and a second substrate having an inlet port and an outlet port for a fluid;
a holding member for holding the flow chip;
a fixing member where the holding member is disposed, and which comes into contact with the second substrate of the flow chip;
a fluid supply unit which supplies the fluid to the inlet port, and which discharges the fluid from the outlet port;
an optical detection unit disposed at a side of the first substrate of the flow chip;
a drive unit driving the holding member in an XY direction; and
a pressurizing unit for pressurizing the holding member or the flow chip against the fixing member,
wherein the pressurizing unit includes a clamp unit for mechanically pressurizing at least two portions of the holding member or the flow chip, and
the clamp unit has a tapered shape.

17. An analysis device comprising:
a flow chip at least including a first substrate having light transparency and a second substrate having an inlet port and an outlet port for a fluid;
a holding member for holding the flow chip;
a fixing member where the holding member is disposed, and which comes into contact with the second substrate of the flow chip;
a fluid supply unit which supplies the fluid to the inlet port, and which discharges the fluid from the outlet port;
an optical detection unit disposed at a side of the first substrate of the flow chip;
a drive unit driving the holding member in an XY direction; and
a pressurizing unit for pressurizing the holding member or the flow chip against the fixing member,
wherein the pressurizing unit includes a clamp unit for mechanically pressurizing at least two portions of the holding member or the flow chip, and
the pressurizing unit is a cover which is rotatably attached to the fixing member and which has an aperture unit, and the clamp unit is formed to protrude from an external periphery to an inner side of the aperture unit.

18. An analysis device comprising:
a flow chip at least including a first substrate having light transparency and a second substrate having an inlet port and an outlet port for a fluid;
a holding member for holding the flow chip;
a temperature adjustment unit where the holding member is disposed, and which comes into contact with the second substrate of the flow chip, and performs temperature adjustment of the flow chip;
a fluid supply unit which supplies the fluid to the inlet port, and which discharges the fluid from the outlet port;
an optical detection unit disposed at a side of the first substrate of the flow chip; and
a drive unit driving the holding member in an XY direction,
wherein the temperature adjustment unit includes a heat block coming into contact with the second substrate, a Peltier device disposed below the heat block, and a heat sink disposed below the Peltier device, and
the heat block includes notch units respectively corresponding to the inlet port and the outlet port, and the notch units include a fluid channel extending to the inlet port and a fluid channel extending from the outlet port.

19. The analysis device according to claim 18, wherein the fluid channel extending to the inlet port and the fluid channel extending from the outlet port are made of a resin member.

20. The analysis device according to claim 16, wherein the holding member includes a chip holding unit having an aperture unit and a cartridge fixing unit, and
the flow chip is disposed at a position of the aperture unit.

21. The analysis device according to claim 20, wherein the fixing member includes a fixing pin, and the cartridge fixing unit of the holding member has a hole at a position corresponding to the fixing pin, and the holding member inserts the fixing pin into the hole to be disposed on the fixing member.

22. The analysis device according to claim 16, wherein the optical detection unit is an incident-light fluorescence microscope, and the optical detection unit includes an LED, an optical filter, and a two-dimensional camera.

23. The analysis device according to claim 16, wherein the second substrate includes reaction portions in a matrix manner and in a regular manner with a regular interval upon a semiconductor light lithography step.

24. The analysis device according to claim 16, wherein the fluid includes nucleotide modified by multiple fluorochromes, polymerase for performing base elongation, cleaning reagent, image obtaining reagent, and protecting group dissociation reagent, and the reaction method is a sequence by sequence (SBS).

25. The analysis device according to claim 16, wherein the fluid includes oligomer modified by multiple fluorochromes, ligase for adding oligomer to DNA base, cleaning reagent, image obtaining reagent, and protecting group dissociation reagent, and the reaction method may be a sequence by ligation (SBL).

26. The analysis device according to claim 16, wherein the fluid supply unit includes at least one syringe and a plurality of valves.

27. The analysis device according to claim 16, wherein the clamp unit is pressurizing four corners of the flow chip.

28. The analysis device according to claim 16, wherein the clamp unit presses two portions of the flow chip in a longitudinal direction.

29. The analysis device according to claim 17, wherein the holding member includes a chip holding unit having an opening aperture unit and a cartridge fixing unit, and the flow chip is disposed at a position of the aperture unit.

30. The analysis device according to claim 29, wherein the fixing member includes a fixing pin, and the cartridge fixing unit of the holding member has a hole at a position corresponding to the fixing pin, and the holding member is installed on the fixing member when the fixing pin is inserted into the hole.

31. The analysis device according to claim 17, wherein the optical detection unit is an incident-light fluorescence microscope, and the optical detection unit includes an LED, an optical filter, and a two-dimensional camera.

32. The analysis device according to claim 17, wherein the second substrate includes reaction portions in a matrix manner and in a regular manner with a regular interval upon a semiconductor light lithography step.

33. The analysis device according to claim 17, wherein the fluid includes nucleotide modified by multiple fluorochromes, polymerase for performing base elongation, cleaning reagent, image obtaining reagent, and protecting group dissociation reagent, and the reaction method is a sequence by sequence (SBS).

34. The analysis device according to claim 17, wherein the fluid includes oligomer modified by multiple fluorochromes, ligase for adding oligomer to DNA base, cleaning reagent, image obtaining reagent, and protecting group dissociation reagent, and the reaction method may be a sequence by ligation (SBL).

35. The analysis device according to claim 17, wherein the fluid supply unit includes at least one syringe and a plurality of valves.

36. The analysis device according to claim 18, wherein the holding member includes a chip holding unit having an aperture unit and a cartridge fixing unit, and the flow chip is disposed at a position of the aperture unit.

37. The analysis device according to claim 36, wherein the temperature adjustment includes a fixing pin, and the cartridge fixing unit of the holding member has a hole at a position corresponding to the fixing pin, and the holding member is installed on the temperature adjustment when the fixing pin is inserted into the hole.

38. The analysis device according to claim 18, wherein the optical detection unit is an incident-light fluorescence microscope, and the optical detection unit includes an LED, an optical filter, and a two-dimensional camera.

39. The analysis device according to claim 18, wherein the second substrate includes reaction portions in a matrix manner and in a regular manner with a regular interval upon a semiconductor light lithography step.

40. The analysis device according to claim 18, wherein the fluid includes nucleotide modified by multiple fluorochromes, polymerase for performing base elongation, cleaning reagent, image obtaining reagent, and protecting group dissociation reagent, and the reaction method is a sequence by sequence (SBS).

41. The analysis device according to claim 18, wherein the fluid includes oligomer modified by multiple fluorochromes, ligase for adding oligomer to DNA base, cleaning reagent, image obtaining reagent, and protecting group dissociation reagent, and the reaction method may be a sequence by ligation (SBL).

42. The analysis device according to claim 18, wherein the fluid supply unit includes at least one syringe and a plurality of valves.
